(19) United States
(12) Patent Application Publication
(10) Pub. No.: US 2025/0114834 A1
(43) Pub. Date: Apr. 10, 2025

(54) A METHOD OF PRODUCING A DIE FOR EXTRUSION OF ALUMINIUM PROFILES, AND AN EXTRUSION DIE, AND A METHOD OF PRODUCING AN EXTRUSION DIE BLANK MATERIAL AND AN EXTRUSION DIE BLANK MATERIAL

(71) Applicant: HYDRO EXTRUDED SOLUTIONS AS, Oslo (NO)

(72) Inventor: Marco PASQUALON, Bierges (BE)

(73) Assignee: HYDRO EXTRUDED SOLUTIONS AS, Oslo (NO)

(21) Appl. No.: 18/865,762

(22) PCT Filed: May 19, 2023
(86) PCT No.: PCT/EP2023/063510

§ 371 Date: Nov. 14, 2024

(30) Foreign Application Priority Data
May 19, 2022 (NO) 20220593

(51) Int. Cl. B21C 25/02; B21C 25/10; B22F 1/054; B22F 3/105; B22F 5/00; B22F 9/04; C22C 33/02; C22C 38/44; C22C 38/52

(52) U.S. Cl. CPC B21C 25/025; B21C 25/10; B22F 1/054; B22F 3/105; B22F 9/04; C22C 33/0278; C22C 38/44; C22C 38/52; B22F 2003/1051; B22F 2005/002; B22F 2009/043; B22F 2301/35

(57) ABSTRACT

A method of producing a die or a die material for extrusion of aluminum profiles, comprising the steps of: providing a first powder, which is a steel powder having the following composition in weight %: C<1.2; Co 6.0-15; Mo 5.0-11.0; Mn 0-1.5; Si 0-1.25; Cr 2-8; Ni 0.5-6.0; P<0.1; balance Fe and unavoidable impurities, said steel powder having a mean particle size of 5-100 um, providing a second powder containing one or more grain growth inhibitors selected among the group comprising carbides, oxides and nitrides, milling at least the steel powder to a mean crystallite size of 20-100 nm, mixing the first and second powders to a powder mixture, wherein the content of the second powder in the powder mixture is in the range of 0.05-2.5 weight %, forming a green body of the powder mixture, and sintering the green body by discharge plasma sintering (SPS), at a temperature in the range of 950-1200° C.

A method of producing a die for extrusion of aluminium profiles, and an extrusion die, and a method of producing an extrusion die blank material and an extrusion die blank material.

### TECHNICAL FIELD

The present invention relates to a method of producing a die for the extrusion of aluminum profiles. The present invention also relates to a die for extrusion of aluminum profiles. The present invention furthermore relates to ta method of producing a die blank material for preparation of a die for extrusion of aluminium profiles, and such die blank material.

### BACKGROUND

The present invention relates to a method of producing a die for extrusion of aluminum or alloys thereof. By means of extrusion, preheated material is pushed through an extrusion die to create solid or hollow objects of a desired cross-sectional profile. Extrusion allows manufacture of complex cross-sections, and finished parts having excellent surface finish can be obtained. In some cases the desired cross-sectional shape of the extruded object may be very complex, which puts high demand on the extrusion die. In aluminium extrusion there are several factors that influence the die lifetime and performance.

The traditional manufacturing method of extrusion die comprises a high isostatic pressure (HIP) step, a hot rolling step and a cut to length step. Patent EP1920079 discloses an example of steel for extrusion die.

Hot extrusion of metal is associated with tribological failure and mechanical gross cracking. Keeping key mechanical and tribological properties through usage time is an objective in developing material and surface conditions of extrusion die. Noticeably hot hardness, tempering resistance and adhesion condition of coating layers (e.g. CVD, PVD) are principal objectives to obtain high die lifetime and performance.

It is thus an object of the present invention to present a method for producing a die material and a die for extrusion of aluminum profiles, and such a die, that has sufficient hardness, tempering resistance and adhesion properties for the adhesion of vapor-deposited layers on a surface thereon.

### SUMMARY

According to a first aspect, the object of the invention is achieved by means of a method of producing a die for extrusion of aluminum profiles, comprising the steps of:

a) providing a first powder, which is a steel powder having the following composition in weight %:

| | |
|---|---|
| C | <1.2; |
| Co | 6.0-15; |
| Mo | 5.0-11.0; |
| Mn | 0-1.5; |
| Si | 0-1.25; |
| Cr | 2-8; |
| Ni | 0.5-6.0; |
| P | <0.1; |

balance Fe and unavoidable/incidental impurities, said steel powder having a mean particle size of 5-100 μm,

b) providing a second powder containing one or more grain growth inhibitors selected among the group comprising carbides, oxides and nitrides,

c) milling at least the steel powder to a mean crystallite size of 20-100 nm,

d) mixing the first and second powders to a powder mixture, wherein the content of the second powder in the powder mixture is in the range of 0.05-2.5 weight %,

e) forming a green body of the powder mixture,

f) sintering the green body by discharge plasma sintering (SPS), at a temperature in the range of 950-1200° C.

The method may further comprise a step (g) of machining the sintered body (obtained in step f) into the extrusion die shape. The shaping step (g) may comprise subtractive machining.

Furthermore, the method may comprise a step (h) comprising preparation of the die surface, and a step (i) depositing a coating layer on the die surface. The coating layer may be a carbo-nitride layer, such as titanium carbo-nitride (Ti(C,N)). The coating layer may be deposited by chemical vapor deposition, CVD, on the surface of the shaped extrusion die.

The coated extrusion die may be subjected to a final heat treatment step, age-hardening, to obtain the final hardness of the material. The heat-treatment can be performed at standard age-hardening temperatures, such as between 400-650° C., for several hours, which age-hardening heat treatment is generally known to the skilled person.

According to further embodiments, the carbon content of the first powder may be lower than 0.8 wt. %, such as lower than 0.5 wt. %, or lower than 0.1 wt. %.

For a specific powder and milling equipment, the crystallite size after milling can be measured by means of X-ray diffraction technique. Once it has been established which milling time is needed to obtain a mean (i.e. average) crystallite size in accordance with the teaching of the present disclosure, that milling time could then be applied to further batches of the same powder to be milled.

By the present disclosed method, a die material for extrusion of aluminium profiles is provided, the extrusion die material has improved mechanical and tribological features, in particular hardness/toughness balance as well as tempering resistance are enhanced compared with die material produced according to traditional methods. Without wishing to be bound by the theory, it is believed that dispersed nanoparticles in the steel grain boundaries contribute to enhanced hot mechanical strength and wear resistance of the steel. Furthermore, the microstructure of the material obtained by the present process leads to an improved adhesion of CVD-coated layers typically used for surface-tribological performance enhancement of aluminum extrusion dies.

Combination of the above material properties used for an aluminum extrusion die is leading to a significant lifetime improvement of the tooling. The microstructure of the material obtained by the process described in this application furthermore leads to a better hot strength/creep resistance, a critical property of the extrusion die in the field of precise tube manufacturing for heat exchanger applications. Another advantage with the present disclosed method is that the method allows for substantially faster preparation of extrusion die material compared with the traditional method using HIP. The present process thus allows to obtain full density aluminium extrusion die blanks based on an on-demand production. Furthermore, the method allows to size blanks ready for machining operations, eliminating cutting to size steps, which reduces the usage of equipment at the die manufacturing.

SPS sintering (spark plasma sintering or discharge plasma sintering, also referred to as pulsed electric current sintering) refers to a pressure sintering process based on the densification of a powder sample by applying a mechanical stress associated with the passage of a pulsed current to heat the sample; for example a sintering method related to hot or high isostatic pressure but using the Joule effect to heat the pre-compacted powder in a hollow cylindrical crucible between two graphite electrodes under an inert atmosphere or under vacuum, the assembly being subjected to a pressure of several mega-pascals under the action of a hydraulic press. The pressure may be from about 1.5 MPa to about 15 MPa, however not limited to the stated range. A direct or alternating current of several kiloamperes, pulsed or not, is applied between the electrodes with a voltage of a few volts. The chosen voltage/amperage (and applied pressure) for a certain green body is dependent on equipment, and should therefore be adapted thereto. Sintering by using a SPS sintering process at a temperature below 1200° C., preferably below 1015° C., promotes a homogeneous distribution of the phases rich in molybdenum and a fine and homogeneous microstructure, which is advantageous for further processing in the die manufacturing sequence through noticeably, but not only, any High or Mid temperature CVD coating process steps.

According to one embodiment, the first powder may comprise, in weight %:

| | |
|---|---|
| C | <1.2; |
| Co | 8.0-9.0; |
| Mo | 6.0-8.0; |
| Mn | 0.1-0.5; |
| Si | 0.05-0.20; |
| Cr | 3-5; |
| Ni | 1.0-3.0; |
| P | <0.1; |

balance Fe and unavoidable/incidental impurities.

The carbon content of the first powder may be lower than 0.8 wt. %, such as lower than 0.5 wt. %, or lower than 0.1 wt. %.

According to one embodiment, the mean particle size of the first powder before milling may be in the range of 10-50 μm. According to one embodiment, the mean particle size of the first powder before milling may be in the range of 15-25 μm. The first powder, before milling, should have a particle size distribution which provides a good tap density, thus providing a good compaction.

According to one embodiment, after milling, the mean crystallite size of the first powder may be 20-60 nm. According to one embodiment, the mean crystallite size of the first powder, after milling, may be 25-50 nm. p According to one embodiment, before milling, the particles of the first powder may have a spherical morphology. By spherical morphology it should be understood that the particles have a general rounded shape, including oval shape.

According to one embodiment, the milling is a type of milling which results in the particles of the first powder having an angular morphology. According to one embodiment, the milling used for achieving the angular morphology may be ball milling. According to one embodiment, the milling is preferably High Energy Milling (HEM). HEM (high energy milling or high efficiency milling) method is a milling technique for roughing that utilizes a lower Radial Depth of Cut (RDOC) and a higher Axial Depth of Cut (ADOC). This milling method spreads wear evenly across the cutting edge, dissipates heat, and reduces the chance of tool failure. The milling technique according to the present disclosure differs from traditional or conventional milling, which typically calls for a higher RDOC and lower ADOC. Further, while traditional milling calls for more axial passes, HEM toolpaths use more passes radially. In one embodiment, it may be provided a milling step or a pre-milling step before the HEM milling step. The milling step results in reduced size of crystallites in the first powder and an increased amount of defects in the powder due to cold welding and breakage. By the milling treatment it is possible to significantly reduce the sintering temperatures and achieve finer final microstructure in the sintered material.

In one embodiment, the milling may be a HEM milling-mixing step. The objective of HEM milling-mixing is to obtain a homogeneous and intimate mixture of the first and second powders. It also appears interesting to observe that the difference in ductility between the first and the second powders makes it possible to improve the reduction in the size of the crystallites of the first powder while carrying out an encapsulation of the particles of the second powder by that of the first powder, which makes it possible to position the particles of the second powder at the grain boundaries of the particles of the first powder.

The combination of the HEM method and SPS sintering makes it possible to obtain sintered parts (blanks) that can be inserted into the conventional die making process chain without the need for any modification, as the consolidated final material blanks can be delivered directly to the extrusion die making process without any additional necessary steps.

In connection to the sintering step, the temperature of the green body may preferably be increased from room temperature to the sintering temperature with 5-100° C./minute, preferably with 15-75° C./minute. Sintering time, at sintering temperature, may be 1-45 minutes, preferably 5-30 minutes. Preferably, the method may comprise a further step of cooling the sintered material without quenching, thus avoiding appearance of metastable phases at room temperature.

All steps of the method may be carried out in an inert atmosphere or in vacuum. Vacuum limits the risk of metal oxidation or nitriding.

According to one embodiment, the content of the second powder in the powder mixture may be in the range of 0.1-1.5 weight %, such as 0.25-1 weight %. According to one embodiment, the second powder contains one or more grain growth inhibitors selected among the group comprising titanium carbide (TIC), tantalum carbide (TaC), tungsten carbide (WC), yttria (Y₂O₃), alumina (Al₂O₃), zirconium oxide (ZrO₂), Silicon nitride (Si₃N₄).

According to one embodiment, the second powder may comprise at least 50 weight %, preferably at least 75 weight % yttria (Y₂O₃).

According to one embodiment, the second powder may be milled together with the first powder in said milling step. According to one embodiment, the mean particle size of the second powder before milling may be less than 100 nm, such as less than 60 nm. There is no lower limit of the particle size of the second powder before milling, however it is understood that the particle size of the second powder before milling is >0.

According to one embodiment, the sintering step may comprise sintering at a temperature in the range of 950-1125° C., such as 960-1050°° C., or 970-1000° C.

According to a second aspect, the object of the invention is also achieved by means of a die for extrusion of aluminum profiles, said die comprising a sintered body, which comprises dispersed intergranular nanoparticles of carbides, oxides and/or nitrides in a steel matrix, said steel matrix having the following composition in weight %:

| | |
|---|---|
| C | <1.2 |
| Co | 6.0-15 |
| Mo | 5.0-11.0 |
| Mn | 0-1.5 |
| Si | 0-1.25 |
| Cr | 2-8 |
| Ni | 0.5-6.0 |
| P | <0.1 |

balance Fe and unavoidable/incidental impurities,

wherein said carbides, oxides and/or nitrides together constitutes 0.05-2.5 weight % of the sintered body.

According to further embodiments, the carbon content may be lower than 0.8 wt. %, such as lower than 0.5 wt. %, or lower than 0.1 wt. %.

According to one embodiment, the steel matrix may comprise, in weight %:

| | |
|---|---|
| C | <1.2 |
| Co | 8.0-9.0 |
| Mo | 6.0-8.0 |
| Mn | 0.1-0.5 |
| Si | 0.05-0.20 |
| Cr | 3-5 |
| Ni | 1.0-3.0 |
| P | <0.1 |

balance Fe and unavoidable/incidental impurities.

According to further embodiments, the carbon content may be lower than 0.8 wt. %, such as lower than 0.5 wt. %, or lower than 0.1 wt. %.

According to one embodiment, the grains of the steel matrix may have an angular morphology. According to one embodiment, the content of said carbides, oxides and/or nitrides may be in the range of 0.1-1.5 weight %, such as 0.25-1 weight %.

According to one embodiment, said carbides, oxides and/or nitrides may consist of at least one of titanium carbide (TIC), tantalum carbide (TaC), tungsten carbide (WC), yttria (Y₂O₃), alumina (Al₂O₃), zirconium oxide (ZrO₂), Silicon nitride (Si₃N₄).

According to one embodiment, said carbides, oxides and/or nitrides may comprise at least 50 weight %, preferably at least 75 weight % yttria (Y₂O₃).

According to one embodiment, the die for extrusion of aluminum profiles may comprise a carbo-nitride coating layer, such as a coating layer of titanium carbo-nitride (Ti(C,N)), on an outer surface of the sintered body.

According to one aspect, the extrusion die is obtained by machining into a final shape a blank produced by the method disclosed hereinabove, optionally preparing the surface, and depositing the carbo-nitride coating layer, such as a coating layer of titanium carbo-nitride (Ti(C,N)), on the final shaped die surface.

According to a third aspect, the present disclosure concerns a method for preparing an extrusion die blank material, the method comprising the steps of:

a) providing a first powder, which is a steel powder having the following composition in weight %:

| | |
|---|---|
| C | <1.2; |
| Co | 6.0-15; |
| Mo | 5.0-11.0; |
| Mn | 0-1.5; |
| Si | 0-1.25; |
| Cr | 2-8; |
| Ni | 0.5-6.0; |
| P | <0.1; |

balance Fe and unavoidable/incidental impurities, said steel powder having a mean particle size of 5-100 μm,

b) providing a second powder containing one or more grain growth inhibitors selected among the group comprising carbides, oxides and nitrides,

c) milling at least the steel powder to a mean crystallite size of 20-100 nm,

d) mixing the first and second powders to a powder mixture, wherein the content of the second powder in the powder mixture is in the range of 0.05-2.5 weight %,

e) forming a green body of the powder mixture,

f) sintering the green body by discharge plasma sintering (SPS), at a temperature in the range of 950-1200° C.

According to one embodiment, the first powder may comprise, in weight %:

| | |
|---|---|
| C | <1.2; |
| Co | 8.0-9.0; |
| Mo | 6.0-8.0; |
| Mn | 0.1-0.5; |
| Si | 0.05-0.20; |
| Cr | 3-5; |
| Ni | 1.0-3.0; |
| P | <0.1; |

balance Fe and incidental impurities.

The carbon content of the first powder may be lower than 0.8 wt. %, such as lower than 0.5 wt. %, or lower than 0.1 wt. %.

According to one embodiment, the mean particle size of the first powder before milling may be in the range of 10-50 μm; or in the range of 15-25 μm.

According to one embodiment, after milling, the mean crystallite size of the first powder may be in the range of 20-60 nm; or in the range of 25-50 nm.

According to one embodiment, before milling, the particles of the first powder may have a spherical or rounded morphology.

According to one embodiment, the milling may be a type of milling which results in the particles of the first powder having an angular morphology.

According to one embodiment, the content of the second powder in the powder mixture may be in the range of 0.1-1.5 weight %; or in the range of 0.25-1 weight %; or in the range of 0.25-1 weight %.

According to one embodiment, the second powder may contain one or more grain growth inhibitors selected among the group comprising titanium carbide (TIC), tantalum carbide (TaC), tungsten carbide (WC), yttria (Y₂O₃), alumina (Al₂O₃), zirconium oxide (ZrO₂), Silicon nitride (Si₃N₄).

According to one embodiment, the second powder may comprise at least 50 weight %, preferably at least 75 weight % yttria (Y₂O₃).

According to one embodiment, the second powder may be milled together with the first powder in said milling step.

According to one embodiment, the sintering step may comprise sintering at a temperature in the range of 950-1125° C.; or 960-1050° C.; or 970-1000° C.

The features and characteristics of the method according to the third aspect are the same as the corresponding steps and features described for the method according to the first aspect. Hence, the same advantages and technical effects are obtained for the same method steps.

According to a fourth aspect, the object of the invention is also achieved by an extrusion die blank material, said extrusion die blank material comprising a sintered body, which comprises dispersed intergranular nanoparticles of carbides, oxides and/or nitrides in a steel matrix, said steel matrix having the following composition in weight %:

| | |
|---|---|
| C | <1.2 |
| Co | 6.0-15 |
| Mo | 5.0-11.0 |
| Mn | 0-1.5 |
| Si | 0-1.25 |
| Cr | 2-8 |
| Ni | 0.5-6.0 |
| P | <0.1 |

balance Fe and unavoidable/incidental impurities,

wherein said carbides, oxides and/or nitrides together constitutes 0.05-2.5 weight % of the sintered body.

According to one embodiment, the steel matrix may comprise, in weight %:

| | |
|---|---|
| C | <1.2 |
| Co | 8.0-9.0 |
| Mo | 6.0-8.0 |
| Mn | 0.1-0.5 |
| Si | 0.05-0.20 |
| Cr | 3-5 |
| Ni | 1.0-3.0 |
| P | <0.1 |

balance Fe and incidental impurities.

According to further embodiments, the carbon content may be lower than 0.8 wt. %, such as lower than 0.5 wt. %, or lower than 0.1 wt. %.

According to one embodiment, the grains of the steel matrix may have an angular morphology.

According to one embodiment, the content of said carbides, oxides and/or nitrides may be in the range of 0.1-1.5 weight %, such as 0.25-1 weight %.

According to one embodiment, said carbides, oxides and/or nitrides may consist of at least one of titanium carbide (TIC), tantalum carbide (TaC), tungsten carbide (WC), yttria (Y₂O₃), alumina (Al₂O₃), zirconium oxide (ZrO₂), Silicon nitride (Si₃N₄).

According to one embodiment, said carbides, oxides and/or nitrides may comprise at least 50 weight %, preferably at least 75 weight % yttria (Y₂O₃).

The term “blank” or “die blank” should be understood to denote a workpiece which may be further processed, or machined, to obtain the final shaped extrusion die.

### BRIEF DESCRIPTION OF THE DRAWINGS

FIG. 1 represents in the form of a histogram a comparison between state-of-the-art embodiment, produced by a method as illustrated in FIG. 3, (left pair of bars), and one embodiment of the present invention (right pair of bars), of steel hardness, Vickers hardness, drop (HV hardness delta on y-axis) during approximate lifetime of an extrusion die at working temperature of 600° C.

FIG. 2 illustrates steps of a manufacturing method of a part or article comprising a HEM milling process and a SPS sintering process according to one embodiment of the present disclosure.

FIG. 3 illustrates steps of a manufacturing method of a part or article according to the state of the art, comprising a high isostatic pressure (HIP) step, a hot rolling step and a cut to length step.

### DETAILED DESCRIPTION

In the following, example embodiments of the invention will be discussed in more detail. It should be understood, however, that the example embodiments are not intended to limit the invention as the scope of the invention is defined in the appended claim set.

The investigation has been performed by evaluating the mechanical properties of steel samples sintered by SPS from a mechanically activated steel powder. The process to produce dense nanostructured samples from a micrometric commercial powder consisted in two steps:

(i) mechanical activation of the elemental powder by milling,

(ii) densification of powder in one step by flash sintering using SPS equipment.

Conditions of powder preparation were selected to produce a batch necessary to perform SPS samples.

Powder was milled in a planetary ball vario-mill with a specific ball milling condition and was established between 0 and 4000 rpm (rotation per minute), for example the disk rotation speed between 0 and +/−4000 rpm for the absolute rotation speed.

In addition, the milling parameters were selected in order to mill between 4 and 8 hours, for producing mechanically activated agglomerates.

According to one example, it was provided steel powders consisting of in weight % (wt. %):

Co: 8-9%

Mo: 6-8%

Cr: 3-5%

Ni: 1-3%

Si: 0.05-0.2%

Mn: 0.1-0.5%

P: <0.1%, the rest being balance Fe and unavoidable/incidental impurities.

Also, a second powder consisting of in weight % (wt. %): between 0.05 and 2.5% of the total content of the powder was added.

Then the powder comprising the steel powder and the second powder was milled in the open air, using a HEM process, so as to obtain steel particles having a crystallite size of less than 60 nanometers. The following milling parameters were used: disk rotation speed of milling: 250 rpm, during 4 hours, under open air, dry process, the mass ratio of powder to ball weight was between ⅕ and 1/9.

Then, the powder was sintered by using a SPS sintering process at a temperature below 1050° C. By observation of the die/samples it was found that the SPS sintering process temperature should preferably be below 1015° C. Temperature was measured directly on the final part or on the tool holder of the part. The SPS sintering parameters were: uniaxial stress 50 MPa, dwell duration 30 minutes, and cooling was carried out without quenching.

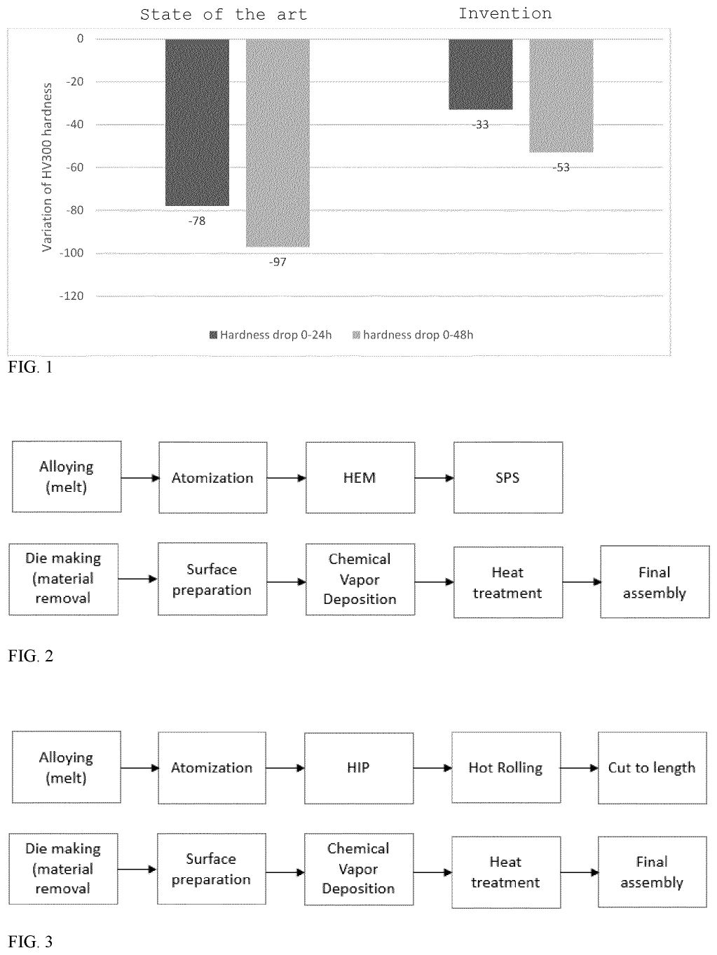

With reference to the right side of FIG. 1, steel hardness drop was reduced in the materials produced according to the preceding embodiment example, compared with a material produced according to a method according to the state of the art (ref. FIG. 3). Identical samples were baked at 600° C., then removed every 24 hours, then allowed to cool to room temperature to make hardness measurements. Hardness measurements were taken every 24 hours and show the evolution of hardness as a function of thermal aging.

FIG. 2 illustrates an example of a manufacturing method of an extrusion die according to the present disclosure, comprising the following steps:
alloying (melt),
atomization of powder comprising steel powder,
HEM milling,
SPS sintering,
die making,
surface preparation,
CVD step,
heat treatment step,

so as to obtain an extrusion die based on an ODS (Oxide Dispersion Strengthened) steel.

Compared with the prior art see FIG. 3, the combination of steps HEM milling and SPS sintering makes it possible to obtain a steel-based die for extrusion of aluminium of aluminium profiles presenting improved mechanical and tribological features, in particular hardness/toughness balance, excellent adhesion of CVD layer to the substrate (die surface), for example titanium carbo-nitride (Ti(C,N)) layers, directly leading to extrusion die lifetime increase. Furthermore, propagation of dislocations, creep, and deformation of the extrusion die are reduced. Beyond above characteristics, the microstructure of the material obtained by the process described in this disclosure is leading to a better hot strength/creep resistance, which are critical properties of the extrusion die in the field of precise tube manufacturing for heat exchanger applications.

1. A method of producing a die for extrusion of aluminum profiles, comprising the steps of:
a) providing a first powder, which is a steel powder having the following composition in weight %:

| | |
|---|---|
| C | <1.2 |
| Co | 6.0-15 |
| Mo | 5.0-11.0 |
| Mn | 0-1.5 |
| Si | 0-1.25 |
| Cr | 2-8 |
| Ni | 0.5-6.0 |
| P | <0.1 |

balance Fe and unavoidable impurities, said steel powder having a mean particle size of 5-100 μm,
b) providing a second powder containing one or more grain growth inhibitors selected among the group comprising carbides, oxides and nitrides,
c) milling at least the steel powder to a mean crystallite size of 20-100 nm,
d) mixing the first and second powders to a powder mixture, wherein the content of the second powder in the powder mixture is in the range of 0.05-2.5 weight %,
e) forming a green body of the powder mixture,
f) sintering the green body by discharge plasma sintering (SPS), at a temperature in the range of 950-1,200° C., and
g) machining a sintered body obtained in step f) into a final die shape.

2. The method according to claim 1, wherein the first powder comprises, in weight %:

| | |
|---|---|
| C | <1.2 |
| Co | 8.0-9.0 |
| Mo | 6.0-8.0 |
| Mn | 0.1-0.5 |
| Si | 0.05-0.20 |
| Cr | 3-5 |
| Ni | 1.0-3.0 |
| P | <0.1 |

balance Fe and unavoidable impurities.

3-9. (canceled)

10. The method according to claim 1, wherein the second powder contains one or more grain growth inhibitors selected among the group comprising titanium carbide (TiC), tantalum carbide (TaC), tungsten carbide (WC), yttria (Y₂O₃), alumina (Al₂O₃), zirconium oxide (ZrO₂), Silicon nitride (Si₃N₄).

11. The method according to claim 1, wherein the second powder comprises at least 50 weight %, or at least 75 weight % yttria (Y₂O₃).

12-13. (canceled)

14. The method according to claim 1, wherein the method further comprises step h) preparation of a die surface, and step i) depositing a coating layer on the die surface.

15. A die for extrusion of aluminum profiles, said die comprising a sintered body, which comprises intergranular nanoparticles of carbides, oxides and/or nitrides located between steel grains in a steel matrix, said steel matrix having the following composition in weight %:

| | |
|---|---|
| C | <1.2 |
| Co | 6.0-15 |
| Mo | 5.0-11.0 |
| Mn | 0-1.5 |
| Si | 0-1.25 |
| Cr | 2-8 |
| Ni | 0.5-6.0 |
| P | <0.1 |

balance Fe and unavoidable impurities,
wherein said carbides, oxides and/or nitrides together constitutes 0.05-2.5 weight % of the sintered body.

16. (canceled)

17. The die according to claim 15, wherein the steel matrix comprises, in weight %:

| | |
|---|---|
| C | <1.2 |
| Co | 8.0-9.0 |
| Mo | 6.0-8.0 |
| Mn | 0.1-0.5 |
| Si | 0.05-0.20 |
| Cr | 3-5 |
| Ni | 1.0-3.0 |
| P | <0.1 |

balance Fe and unavoidable impurities.

18. The die according to claim 15, wherein the grains of the steel matrix have an angular morphology.

19. (canceled)

20. The die according to claim 15, wherein said carbides, oxides and/or nitrides consists of at least one of titanium carbide (TIC), tantalum carbide (TaC), tungsten carbide (WC), yttria (Y₂O₃), alumina (Al₂O₃), zirconium oxide (ZrO₂), Silicon silicon nitride (Si₃N₄).

21. The die according to claim 15, wherein said carbides, oxides and/or nitrides comprises at least 50 weight %, or at least 75 weight % yttria (Y₂O₃).

22. The die according to claim 15, wherein the die comprises a carbo-nitride coating layer, such as a layer of titanium carbo-nitride (Ti(C,N)), on an outer surface of the sintered body.

23. A method of preparing of a blank material for an extrusion die, comprising the steps of:
a) providing a first powder, which is a steel powder having the following composition in weight %:

| | |
|---|---|
| C | <1.2 |
| Co | 6.0-15 |
| Mo | 5.0-11.0 |
| Mn | 0-1.5 |
| Si | 0-1.25 |
| Cr | 2-8 |
| Ni | 0.5-6.0 |
| P | <0.1 |

balance Fe and incidental impurities, said steel powder having a mean particle size of 5-100 μm,
b) providing a second powder containing one or more grain growth inhibitors selected among the group comprising carbides, oxides and nitrides,
c) milling at least the steel powder to a mean crystallite size of 20-100 nm,
d) mixing the first and second powders to a powder mixture, wherein the content of the second powder in the powder mixture is in the range of 0.05-2.5 weight %,
e) forming a green body of the powder mixture,
f) sintering the green body by discharge plasma sintering (SPS), at a temperature in the range of 950-1,200° C.

24. The method according to claim 23, wherein the first powder comprises, in weight %:

| | |
|---|---|
| C | <1.2 |
| Co | 8.0-9.0 |
| Mo | 6.0-8.0 |
| Mn | 0.1-0.5 |
| Si | 0.05-0.20 |
| Cr | 3-5 |
| Ni | 1.0-3.0 |
| P | <0.1 |

balance Fe and incidental impurities.

25-30. (canceled)

31. The method according to claim 23, wherein the second powder contains one or more grain growth inhibitors selected among the group comprising titanium carbide (TiC), tantalum carbide (TaC), tungsten carbide (WC), yttria (Y₂O₃), alumina (Al₂O₃), zirconium oxide (ZrO₂), Silicon silicon nitride (Si₃N₄).

32. The method according to claim 23, wherein the second powder comprises at least 50 weight %, or at least 75 weight % yttria (Y₂O₃).

33-34. (canceled)

35. An extrusion die blank material, said extrusion die blank material comprises a sintered body, which comprises dispersed intergranular nanoparticles of carbides, oxides and/or nitrides in a steel matrix, said steel matrix having the following composition in weight %:

| | |
|---|---|
| C | <1.2 |
| Co | 6.0-15 |
| Mo | 5.0-11.0 |
| Mn | 0-1.5 |
| Si | 0-1.25 |
| Cr | 2-8 |
| Ni | 0.5-6.0 |
| P | <0.1 |

balance Fe and incidental impurities,
wherein said carbides, oxides and/or nitrides together constitutes 0.05-2.5 weight % of the sintered body.

36. The extrusion die blank material according to claim 35, wherein the steel matrix comprises, in weight %:

| | |
|---|---|
| C | <1.2 |
| Co | 8.0-9.0 |
| Mo | 6.0-8.0 |
| Mn | 0.1-0.5 |
| Si | 0.05-0.20 |
| Cr | 3-5 |
| Ni | 1.0-3.0 |
| P | <0.1 |

balance Fe and incidental impurities.

37. (canceled

38. The extrusion die blank material according to claim 35, wherein the grains of the steel matrix have an angular morphology.

39. (canceled)

40. The extrusion die blank material according to claim 35, wherein said carbides, oxides and/or nitrides consist of at least one of titanium carbide (TiC), tantalum carbide (TaC), tungsten carbide (WC), yttria (Y₂O₃), alumina (Al₂O₃), zirconium oxide (ZrO₂), Silicon nitride (Si₃N₄).

41. The extrusion die blank material according to claim 35, wherein said carbides, oxides and/or nitrides comprise at least 50 weight %, or at least 75 weight % yttria (Y₂O₃).
